(19) United States
(12) Patent Application Publication
(10) Pub. No.: US 2020/0313920 A1
(43) Pub. Date: Oct. 1, 2020

(54) METHOD FOR RECORDING A MULTIMEDIA CALL BY COMMON CONSENT VIA AN INSTANT COMMUNICATION SOFTWARE PROGRAM, AND ELECTRONIC DEVICES AND COMPUTER PROGRAM PRODUCTS THAT IMPLEMENT THE SAME

(71) Applicant: Letstalk Technology Limited, Taipei City (TW)

(72) Inventors: Chan-Guan KOH, Taipei City (TW); Chun-Hao CHEN, Taipei City (TW); Tzu-Ying WANG, Taipei City (TW); Sheng-Yen FANG, Taipei City (TW); Chien-Cheng LU, Taipei City (TW); I-Yun CHAO, Taipei City (TW)

(21) Appl. No.: 16/460,330

(22) Filed: Jul. 2, 2019

(30) Foreign Application Priority Data
Mar. 25, 2019 (TW) 108110290

(51) Int. Cl. H04L 12/18; H04L 12/58

(52) U.S. Cl. CPC H04L 12/1831; H04L 51/046

(57) ABSTRACT

A method for recording a multimedia call with common consent via an instant communication software program is proposed. Via execution of the software program, when an electronic device makes a multimedia call to another electronic device, a recording notification is provided to said another electronic device for notifying a user of said another electronic device that the multimedia call would be recorded. After the multimedia call has ended, one of the two electronic devices generates a recording file for the multimedia call, and transmits the recording file to a virtual chat room created for the two electronic devices.

### CROSS-REFERENCE TO RELATED APPLICATION

This application claims priority of Taiwanese Invention Patent Application No. 108110290, filed on Mar. 25, 2019.

### FIELD

The disclosure relates to a method for recording a multimedia call via an instant communication software program, and more particularly to a method for recording a multimedia call with common consent via an instant communication software program.

### BACKGROUND

Nowadays, various electronic devices, such as mobile phones, tablet computers, notebook computers, desktop computers, etc., allow users to, when executing an instant communication software program, make a voice call or a video call to another user (target user) via a network by selecting the target user from a contact list, and then triggering an option for making a voice call or a video call. While most conventional instant communication software programs lack the functionality of recording the conversations or interactions during the call, users may sometimes require backup for the content of the call.

### SUMMARY

Therefore, an object of the disclosure is to provide a method that enables users of an instant communication software program to acquire a recording file for a multimedia call held by execution of the instant communication software program, and electronic devices and computer program products that implement the method.

According to the disclosure, the method for recording a multimedia call with common consent via an instant communication software program includes: by the first electronic device that executes an instant communication software program, creating a virtual chat room for the first and second electronic devices; by the first electronic device, receiving an instruction for calling the second electronic device with recording; by the first electronic device upon receipt of the instruction for calling the second electronic device with recording, making a multimedia call to the second electronic device and simultaneously transmitting a recording notification to the second electronic device for notifying a user of the second electronic device that the multimedia call will be recorded; by the first electronic device, commencing the multimedia call with the second electronic device in response to receipt of a notification of accepting the multimedia call returned by the second electronic device; by one of the first and second electronic devices, recording the multimedia call as the multimedia call is in progress; by said one of the first and second electronic devices, generating a recording file based on the recording of the multimedia call after the multimedia call has ended; and by said one of the first and second electronic devices, transmitting the recording file to the virtual chat room.

According to the disclosure, an electronic device is proposed to include an input unit for operation by a user, a storage unit storing an instant communication software program, a display unit, a communication unit, and a processing unit electrically coupled to the input unit, the storage unit, the display unit and the communication unit. The processing unit is configured to, when executing the instant communication software program stored in the storage unit: create a virtual chat room for the electronic device and said another electronic device, and cause the display unit to display the virtual chat room; upon receipt of an instruction for calling said another electronic device with recording, make a multimedia call to said another electronic device via the communication unit and simultaneously transmit a recording notification to said another electronic device via the communication unit for notifying a user of said another electronic device that the multimedia call will be recorded; in response to receipt of a notification of accepting the multimedia call returned by said another electronic device via the communication unit, commence the multimedia call with said another electronic device with use of the communication unit, and record the multimedia call as the multimedia call is in progress; generate a recording file based on the recording of the multimedia call after the multimedia call has ended; and transmit the recording file to the virtual chat room via the communication unit.

According to the disclosure, an electronic device is proposed to include an input unit for operation by a user, a storage unit storing an instant communication software program, a display unit, a communication unit, and a processing unit electrically coupled to the input unit, the storage unit, the display unit and the communication unit. The processing unit is configured to, when executing the instant communication software program stored in the storage unit: receive an incoming call alert and a recording notification in relation to a multimedia call with call recording from another electronic device via the communication unit; upon receipt of a user operation via the input unit to accept the multimedia call, return, via the communication unit, a notification of accepting the multimedia call to said another electronic device; commence the multimedia call with said another electronic device with use of the communication unit; record the multimedia call as the multimedia call is in progress; generate a recording file based on the recording of the multimedia call after the multimedia call has ended; and transmit the recording file to a virtual chat room created for the electronic device and said another electronic device via the communication unit.

According to the disclosure, a computer program is proposed to include a non-volatile and tangible computer-accessible medium that includes an instant communication software program that, when loaded and executed by a first electronic device and a second electronic device, causes the first and second electronic devices to perform the proposed method of this disclosure, wherein said one of the first and second electronic devices is the first electronic device.

According to the disclosure, a computer program is proposed to include a non-volatile and tangible computer-accessible medium that includes an instant communication software program that, when loaded and executed by a first electronic device and a second electronic device, causes the first and second electronic devices to perform the proposed method of this disclosure, wherein said one of the first and second electronic devices is the second electronic device.

### BRIEF DESCRIPTION OF THE DRAWINGS

Other features and advantages of the disclosure will become apparent in the following detailed description of the embodiment (s) with reference to the accompanying drawings, of which:

FIG. 1 is a flow chart illustrating a first embodiment of the method for recording a multimedia call with common consent via an instant communication software program according to the disclosure;

FIG. 2 is a block diagram illustrating a system that includes a first electronic device and a second electronic device to implement embodiments of the method according to this disclosure;

FIG. 3 is a schematic diagram illustrating a virtual chat room created for the first electronic device and the second electronic device;

FIG. 4 is a schematic diagram illustrating an unlocking screen displayed by the second electronic device;

FIG. 5 is a schematic diagram illustrating an answering screen displayed by the second electronic device;

FIG. 6 is a schematic diagram illustrating a communication screen displayed by the second electronic device;

FIG. 7 is a schematic diagram illustrating a communication screen displayed by the first electronic device; and

FIG. 8 is a schematic diagram illustrating the virtual chat room displayed by the first electronic device after the multimedia call has ended.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

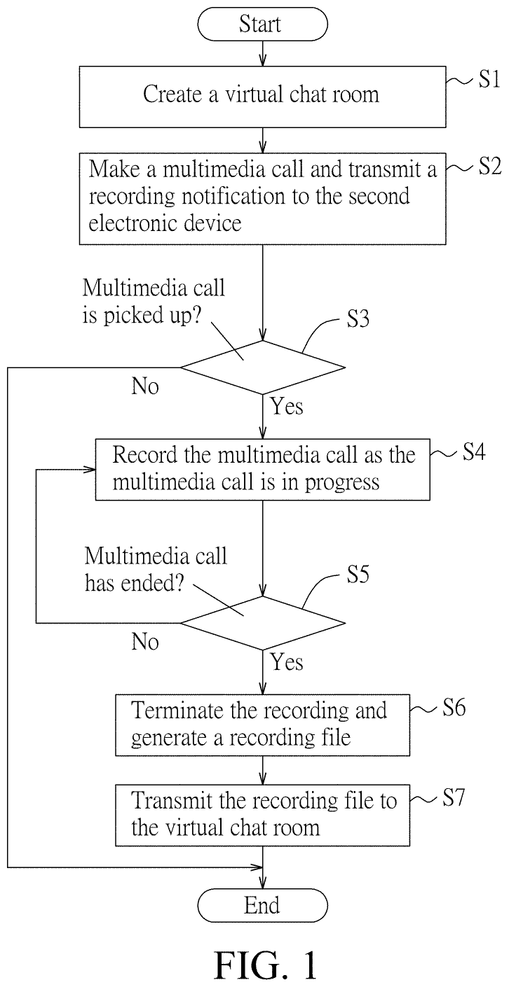

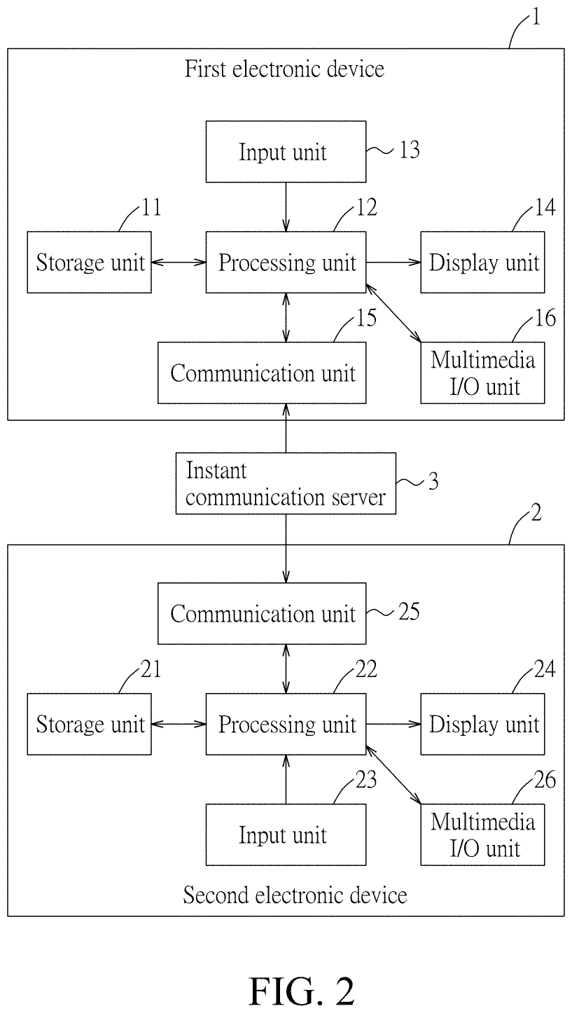

Referring to FIG. 1, the first embodiment of the method for recording a multimedia call with common consent via an instant communication software program is shown to be applied to instant communication between a first electronic device 1 and a second electronic device 2, as shown in FIG. 2. In this embodiment, each of the first and second electronic devices 1, 2 is exemplified as a smartphone, and includes a storage unit 11, 21 (e.g., a flash drive) that stores the instant communication software program therein, a processing unit 12, 22 (e.g., a processor), an input unit 13, 23 (e.g., a touch screen), a display unit 14, 24 (e.g., an LCD screen), a communication unit 15, 25 (e.g., a wireless module, which may use any conventional wireless communication technology, such as WiFi, telecommunication technologies like 4G, etc.), and a multimedia input/output (I/O) unit 16, 26 (e.g., a microphone module, a speaker module, a camera module for input/output of voices and/or images). In some cases, the instant communication software program may be stored in a cloud storage that is accessible to the first and second electronic devices 1, 2; and for each of the first and second electronic devices 1, 2, the input unit 13, 23 and the display unit 14, 24 thereof may be integrated into a single component, such as an LCD panel having touch function. In other embodiments, each of the first and second electronic devices 1, 2 may be a notebook computer, a tablet computer, a desktop computer, etc., of which the storage unit 11, 21 may be a hard disk drive, of which the input unit 13, 23 may include a keyboard and a computer mouse, etc., and of which the communication unit 15, 25 may be a network adapter, but this disclosure is not limited in this respect. In this embodiment, the first and second electronic devices 1, 2 are coupled to an instant communication server 3 via a network (e.g., the Internet) by executing the instant communication software program, so as to perform the embodiment of the method according to this disclosure via the instant communication server 3. In practice, the embodiments of the method according to this disclosure may be implemented as program code of the instant communication software program, which is stored in a non-volatile and tangible computer-accessible storage media, such as optical disks, hard disk drives, flash drives, solid state drives, and the like, and sold as a computer program product for the first and second electronic devices 1, 2 to install and/or execute the program code. In this embodiment, it is exemplified that the first and second electronic devices 1, 2 both have the instant communication software program installed in the corresponding storage units 11, 21, and cooperatively implement the embodiment by both executing the instant communication software program.

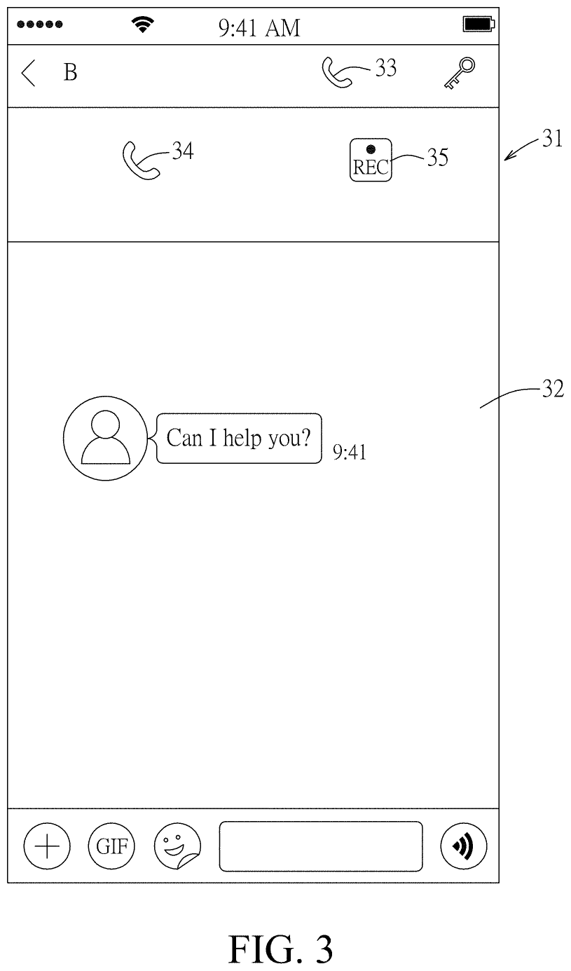

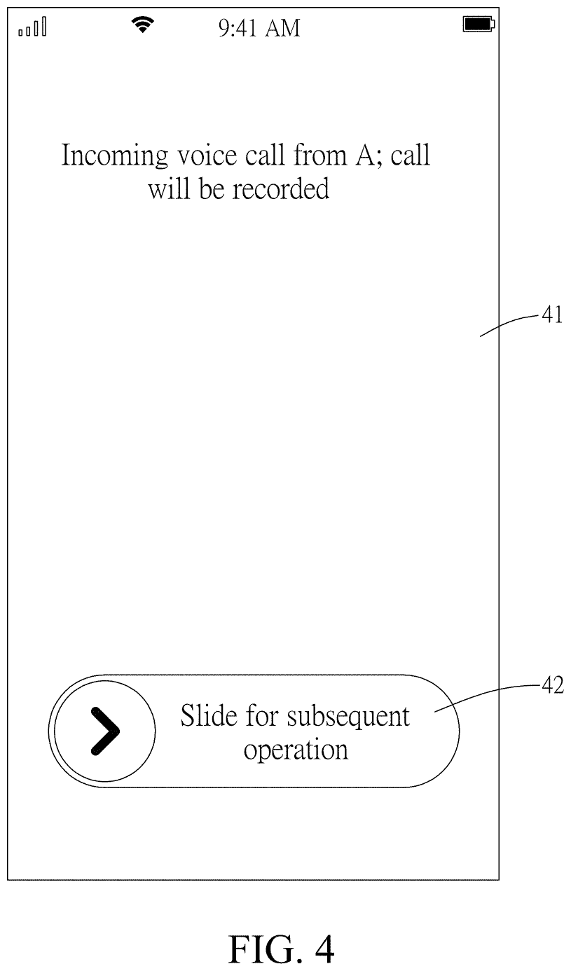

At first, the processing unit 12 of the first electronic device 1 executes the instant communication software program stored in the storage unit 11, and the user (denoted by “A” in FIGS. 4-6) of the first electronic device 1 operates the input unit 13 to select another user (denoted by “B” in FIGS. 3, 7 and 8) corresponding to the second electronic device 2 from a friends list or a contact list, so as to generate a request for instant communication with the second electronic device 2 that executes the instant communication software program. In step S1, the processing unit 12 creates a virtual chat room 31 for the first and second electronic devices 1, 2, and causes the display unit 14 to display an interface of the virtual chat room 31, as exemplified in FIG. 3, in response to the request for instant communication with the second electronic device 2. In addition to a chat window 32 for sending and receiving text messages, the virtual chat room 31 may further include a call option 33 for making a multimedia call. The term “multimedia” herein refers to content provided in an audio format or a video (or audiovisual) format, and does not refer to content in a pure text format. In this embodiment, the multimedia call is exemplified as a voice call, but this disclosure is not limited in this respect. In other embodiments, the multimedia call may be a video call. When the call option 33 is triggered (e.g., the user (A) taps the touch screen of the first electronic device 1 at a location corresponding in position to the call option 33), the processing unit 12 causes the display unit 14 to display a first calling icon 34 (ordinary-call option) for an ordinary voice call and a second calling icon 35 (recording-call option) for a voice call with call recording. Like the conventional voice call function, when the first calling icon 34 is tapped (i.e., the ordinary-call option is triggered) on the input unit 13, the input unit 13 transmits an instruction for calling the second electronic device 2 to the processing unit 12, and the processing unit 12 makes a multimedia call (voice call in this example) to the second electronic device 2 via the communication unit 15 in response to receipt of the instruction for calling the second electronic device 2; and after receipt of a notification of accepting the multimedia call, multimedia communication (e.g., voice communication in this example) would be established between the users (A) and (B) via the first and second electronic device 1, 2, and the multimedia call thus established will not be recorded.

In step S2, when the second calling icon 35 is tapped (i.e., the recording-call option is triggered) on the input unit 13, the input unit 13 transmits an instruction for calling the second electronic device 2 with call recording to the processing unit 12, and the processing unit 12, in response to receipt of the instruction for calling the second electronic device 2 with call recording, makes a multimedia call (voice call in this example) to the second electronic device 2, and simultaneously transmits a recording notification to the second electronic device 2 for notifying the user of the second electronic device 2 that the multimedia call will be recorded. For example, upon receipt of an incoming call alert and the recording notification in relation to the multimedia call with call recording via the communication unit 25, the processing unit 22 may cause the display unit 24 to display, when the second electronic device 2 is in a power-saving mode, an unlocking screen 41 that shows, as shown in FIG. 4, the recording notification exemplified to read “Incoming voice call from A; call will be recorded” for notifying the user (B) that the incoming multimedia call, if accepted, will be recorded. In addition, the unlocking screen 41 further shows an unlock interface 42 for user operation to allow for subsequent operations to accept or to reject the multimedia call.

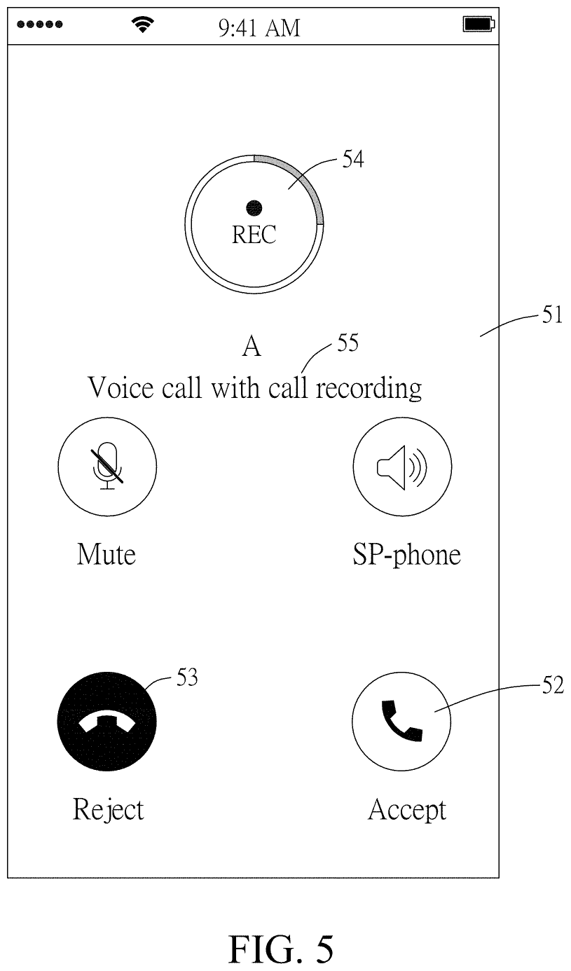

Then, when the user (B) of the second electronic device 2 performs an unlock operation on the unlock interface 42 in the unlocking screen 41, or if the multimedia call with call recording comes in when the second electronic device 2 is unlocked and in use, the processing unit 22 may cause the display unit 24 to display, as shown in FIG. 5, an answering screen 51 that shows an accepting icon 52 and a rejecting icon 53 for the user (B) to perform the intended action, and that further shows a recording pattern 54, and a text message 55 exemplarily reading “Voice call with call recording”. When the user (B) taps the accepting icon 52 to accept the multimedia call, the processing unit 22 returns a notification of accepting the multimedia call to the first electronic device 1 via the communication unit 25. Alternatively, the user (B) may tap the rejecting icon 53 to refuse the multimedia call.

It is noted that, in some cases, the user (A) may operate the first electronic device 1 to make a multimedia call to the second electronic device 2 without creating a virtual chat room first. For example, the instant communication software program may be designed in such a way that the user can trigger the ordinary-call option or the recording-call option from the friends list or contact list, so the virtual chat room may not be created at this time, and the flow of the method will start from step S2.

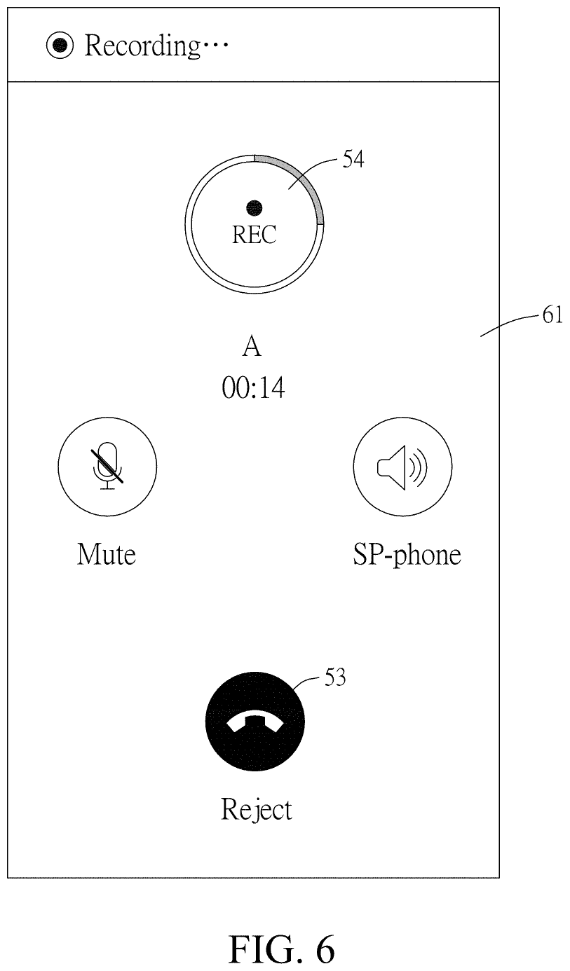

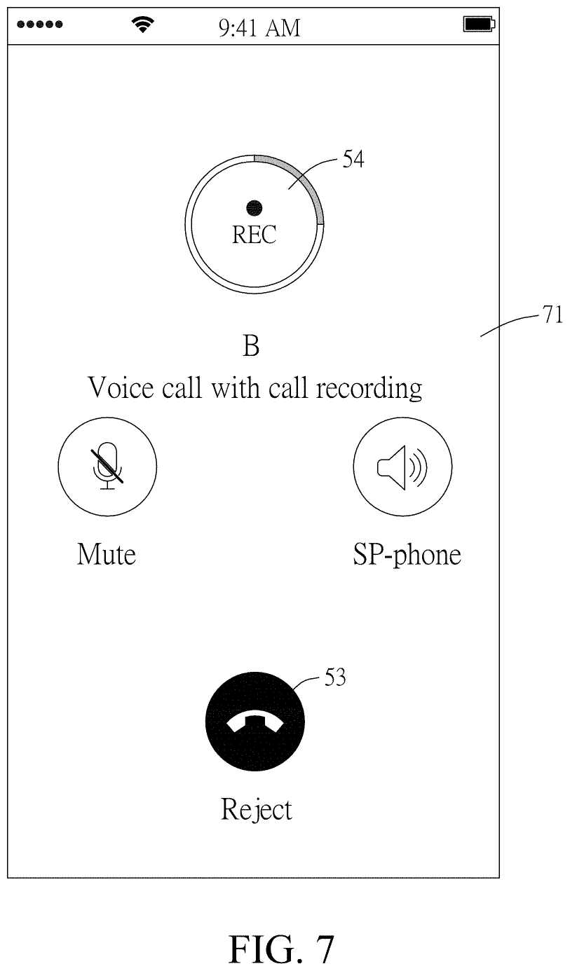

In step S3, the processing unit 12 determines whether the multimedia call has been accepted by the second electronic device 2. Upon receipt of the notification of accepting the multimedia call from the second electronic device 2 via the communication unit 15, the processing unit 12 determines that the multimedia call has been accepted and commences the multimedia call, and the flow goes to step S4, where the first electronic device 1 records the multimedia call with the second electronic device 2 as the multimedia call is in progress. In order to further ensure that the user (B) of the second electronic device 2 is aware that the multimedia call will be recorded, the processing unit 12 may transmit a voice notification message to the second electronic device 2 via the communication unit 15. Referring to FIGS. 6 and 7, once the multimedia call has begun, the processing units 12, 22 respectively of the first and second electronic devices 1, may cause the corresponding display units 14, 24 to each display a communication screen 71, 61 that shows the recording pattern 54 indicating that the multimedia call is being recorded (or will be recorded). The processing unit 22 of the second electronic device 2 further causes a speaker of the multimedia I/O unit 26 to audibly output the voice notification message received from the first electronic device 1 to notify the user (B) that the multimedia call will be recorded. The voice notification message may read, for example, “The conversation or interaction in this call will be recorded after the beep”.

During the multimedia call between the first and second electronic devices 1, 2, the processing unit 12, in addition to performing the recording of the multimedia call, continuously determines whether the multimedia call has ended (step S5). For example and referring to FIG. 6, when the rejecting icon 53 in the communication screen 61 is tapped by the user (B) on the touch screen of the second electronic device 2, the processing unit 22 transmits an end notification to the first electronic device 1. Referring to FIG. 7, when the rejecting icon 53 in the communication screen 71 shown by the touch screen of the first electronic device 1 is tapped by the user (A), the processing unit 12 would receive the end notification from the touch screen. The processing unit 12 determines that the multimedia call has ended upon receipt of the end notification, terminates the recording of the multimedia call, generates a recording file, and stores the recording file into the storage unit 11 (step S6). Since voice communication is a conventional function for instant communication software programs and is not the key point of this disclosure, details thereof are omitted herein for the sake of brevity. It is noted that FIGS. 3 to 8 are used to illustrate an exemplary implementation of this embodiment, and this disclosure is not limited to such.

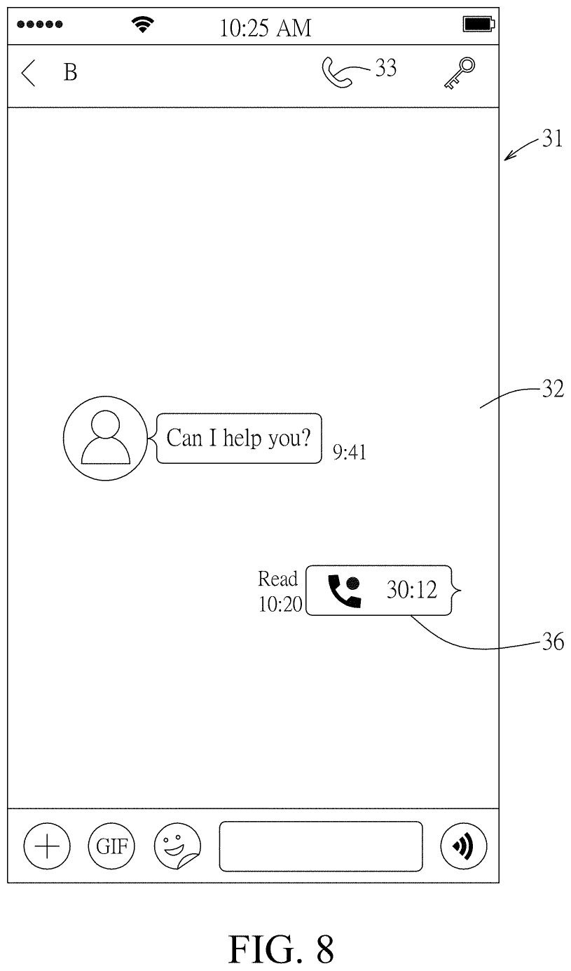

In step S7 and referring to FIG. 8, after the multimedia call has ended, the processing unit 12 transmits the recording file to the virtual chat room 31 that is shared with the second electronic device 2, and the virtual chat room 31 shows an icon 36 representing the recording file and a message (“Read”) indicating that the first electronic device 1 has acquired the recording file. In the cases that the virtual chat room was not created before the multimedia call was made, the virtual chat room may be created (i.e., step S1) at this time, or at any time between steps S2 and S7 in the background. Accordingly, the user (A, B) of each of the first and second electronic devices 1, 2 may execute the recording file by tapping the icon 36 on the touch screen of the first/second electronic device 1, 2 to reproduce the multimedia call or save the recording file in the respective storage unit 11, 21 to back up the multimedia call.

A second embodiment of the method for recording a multimedia call with common consent via an instant communication software program according to this disclosure is similar to the first embodiment, and differs from the first embodiment in that steps S4 to S7 are performed by the second electronic device 2 in the second embodiment. In the second embodiment, after the processing unit 12 of the first electronic device 1 makes a multimedia call and transmits the recording notification to the electronic device 2 (step S2), the processing unit 22 of the second electronic device 2 causes the display unit 24 to display the unlocking screen 41, as shown in FIG. 4.

Referring to FIG. 5, when the user (B) accepts the multimedia call by tapping the accepting icon 52, the processing unit 22 receives an accepting instruction from the input unit 23, transmits the notification of accepting the multimedia call to the first electronic device 1 via the communication unit 25, and performs step S4. In step S4, the processing unit 22 records the multimedia call as the multimedia call with the first electronic device 1 is in progress and causes the display unit 24 to display the communication screen 61, as shown in FIG. 6. In one implementation, the processing unit 22 may cause the speaker of the multimedia I/O unit 26 to audibly output a voice notification message for notifying the user (B) of the second electronic device 2 that the multimedia call will be recorded. The voice notification message may be a message prepared by the user (B) of the second electronic device in advance, or provided by the first electronic device 1 along with the recording notification as described for the first embodiment.

During the multimedia call between the first and second electronic devices 2, the processing unit 22, in addition to performing the recording of the multimedia call, continuously determines whether the multimedia call has ended (step S5). Referring to FIG. 6, when the rejecting icon 53 in the communication screen 61 is tapped by the user (B) on the touch screen of the second electronic device 2, the processing unit 22 receives an end notification. Or, referring to FIG. 7, when the rejecting icon 53 in the communication screen 71 shown by the touch screen of the first electronic device 1 is tapped by the user (A), the processing unit 12 would transmit the end notification to the second electronic device 2. The processing unit 22 determines that the multimedia call has ended upon receipt of the end notification, terminates the recording of the multimedia call, generates a recording file, and stores the recording file into the storage unit 21 (step S6).

In step S7 and referring to FIG. 8, after the multimedia call has ended, the processing unit 22 transmits the recording file to the virtual chat room 31 that is shared with the first electronic device 1, and the virtual chat room 31 shows an icon 36 representing the recording file. Accordingly, the user (A, B) of each of the first and second electronic devices 1, 2 may execute the recording file to reproduce the multimedia call or save the recording file in the respective storage unit 11, 21 to back up the multimedia call by tapping the icon 36 on the touch screen of the first/second electronic device 1, 2.

In summary, the embodiments of this disclosure may ensure that the recording of the multimedia call is made with common consent (i.e., agreed by the user (B) of the second electronic device 2 to whom the user (A) makes the multimedia call), and the multimedia call is recorded by either the first electronic device 1 or the second electronic device 2. Then, the recording file thus generated would be transmitted to the virtual chat room 31 that is created for the first and second electronic devices 1, 2, so both of the first and second electronic devices 2 can acquire the recording file to back up the multimedia call.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for recording a multimedia call with common consent via an instant communication software program, comprising:
by the first electronic device that executes an instant communication software program, creating a virtual chat room for the first and second electronic devices;
by the first electronic device, receiving an instruction for calling the second electronic device with call recording;
by the first electronic device upon receipt of the instruction for calling the second electronic device with call recording, making a multimedia call to the second electronic device and simultaneously transmitting a recording notification to the second electronic device for notifying a user of the second electronic device that the multimedia call will be recorded;
by the first electronic device, commencing the multimedia call with the second electronic device in response to receipt of a notification of accepting the multimedia call returned by the second electronic device;
by one of the first and second electronic devices, recording the multimedia call as the multimedia call is in progress;
by said one of the first and second electronic devices, generating a recording file based on the recording of the multimedia call after the multimedia call has ended; and
by said one of the first and second electronic devices, transmitting the recording file to the virtual chat room.

2. The method of claim 1, wherein the virtual chat room includes a recording-call option to be triggered by a user of the first electronic device for generation of the instruction for calling the second electronic device with call recording.

3. The method of claim 1, wherein the second electronic device executes the instant communication software program to perform the multimedia call with the first electronic device;
said method further comprising:
by the second electronic device and at a beginning of the multimedia call, outputting audibly a voice notification message for notifying a user of the second electronic device that the multimedia call will be recorded.

4. The method of claim 3, further comprising, before the outputting audibly the voice notification message:
by the first electronic device, transmitting the voice notification message to the second electronic device.

5. The method of claim 1, further comprising:
by each of the first and second electronic devices and during the multimedia call, displaying a recording pattern that indicates that the multimedia call is being recorded.

6. An electronic device for recording a multimedia call with common consent via an instant communication software program, comprising:
an input unit for operation by a user;
a storage unit storing an instant communication software program;
a display unit;
a communication unit; and
a processing unit electrically coupled to said input unit, said storage unit, said display unit and said communication unit, and configured to, when executing the instant communication software program stored in said storage unit:
create a virtual chat room for said electronic device and said another electronic device, and cause said display unit to display the virtual chat room;
upon receipt of an instruction for calling said another electronic device with call recording, make a multimedia call to said another electronic device via said communication unit and simultaneously transmit a recording notification to said another electronic device via said communication unit for notifying a user of said another electronic device that the multimedia call will be recorded;
in response to receipt of a notification of accepting the multimedia call returned by said another electronic device via said communication unit, commence the multimedia call with said another electronic device with use of said communication unit, and record the multimedia call as the multimedia call is in progress;
generate a recording file based on the recording of the multimedia call after the multimedia call has ended; and
transmit the recording file to the virtual chat room via said communication unit.

7. The electronic device of claim 6, wherein said processing unit is further configured to transmit, at a beginning of the multimedia call, a voice notification message to said another electronic device via said communication unit for said another electronic device to audibly output the voice notification message to notify a user of said another electronic device that the multimedia call will be recorded.

8. The electronic device of claim 6, wherein said processing unit is further configured to cause said display unit to display, during the multimedia call, a recording pattern that indicates that the recording is being recorded.

9. An electronic device for recording a multimedia call with common consent via an instant communication software program, comprising:
an input unit for operation by a user;
a storage unit storing an instant communication software program;
a display unit;
a communication unit; and
a processing unit electrically coupled to said input unit, said storage unit, said display unit and said communication unit, and configured to, when executing the instant communication software program stored in said storage unit:
receive an incoming call alert and a recording notification in relation to a multimedia call with call recording from another electronic device via said communication unit;
upon receipt of a user operation via said input unit to accept the multimedia call, return, via said communication unit, a notification of accepting the multimedia call to said another electronic device;
commence the multimedia call with said another electronic device via said communication unit after returning the notification of accepting the multimedia call;
record the multimedia call as the multimedia call is in progress;
generate a recording file based on the recording of the multimedia call after the multimedia call has ended; and
transmit the recording file to a virtual chat room created for said electronic device and said another electronic device via said communication unit.

10. The electronic device of claim 9, further comprising a speaker unit coupled to said processing unit, wherein said processing unit is further configured to cause, at a beginning of the multimedia call, said speaker unit to audibly output a voice notification message for notifying a user of said electronic device that the multimedia call will be recorded.

11. The electronic device of claim 9, wherein said processing unit is further configured to cause said display unit to display, during the multimedia call, a recording pattern that indicates the multimedia call is being recorded.

12. A computer program product, comprising a non-volatile and tangible computer-accessible medium that includes an instant communication software program that, when loaded and executed by a first electronic device and a second electronic device, causes the first and second electronic devices to perform the method as claimed in claim 1, wherein said one of the first and second electronic devices is the first electronic device.

13. A computer program product, comprising a non-volatile and tangible computer-accessible medium that includes an instant communication software program that, when loaded and executed by a first electronic device and a second electronic device, causes the first and second electronic devices to perform the method as claimed in claim 1, wherein said one of the first and second electronic devices is the second electronic device.
